(19) United States
(12) Patent Application Publication
(10) Pub. No.: US 2013/0027164 A1
(43) Pub. Date: Jan. 31, 2013

(54) REACTOR AND ELECTRIC POWER CONVERTER USING REACTOR

(71) Applicant: Yoshihiko OOYAMA, Chiryu-shi (JP)

(72) Inventor: Yoshihiko OOYAMA, Chiryu-shi (JP)

(73) Assignee: DENSO CORPORATION, Kariya-city (JP)

(21) Appl. No.: 13/560,117

(22) Filed: Jul. 27, 2012

(30) Foreign Application Priority Data
Jul. 28, 2011 (JP) 2011-165735

(51) Int. Cl. H01F 27/02

(52) U.S. Cl. 336/90

(57) ABSTRACT

A reactor has a cylindrical coil which is energized to create a magnetic flux, a core composed of magnetic powder mixed resin, the coil being buried in the core. The reactor has an inner core which is provided in an inner periphery of the coil and extends along an axial direction of the coil. The reactor has a case in which the coil, the core and the inner core are disposed. The case has a projection which projects inside of the case and a concave portion which is concave toward a projecting direction of the projection. The case including the projection and concave portion is formed in one piece by using die casting.

### CROSS-REFERENCE TO RELATED APPLICATION

This application is based on and claims the benefit of priority from earlier Japanese Patent Application No. 2011-165735 filed Jul. 28, 2011, the description of which is incorporated herein by reference.

### BACKGROUND

1. Technical Field

The present invention relates to a reactor and an electric power converter using the reactor. In particular, the present invention relates to a reactor having a projection inside of a coil.

2. Related Art

Conventionally, various structures are known as reactors which are used for electric power converters such as inverters used In vehicles and so on (refer to Japanese Patent Application Publication No. 2010-199257 and Japanese Patent Application Publication No. 2010-212632).

An example of the above described reactors is a reactor having a coil which is energized to create a magnetic flux, a core in which the coil is buried, and, a metallic case in which the coil and core are disposed. The core consists of magnetic powder mixed resin which is made by mixing magnetic powder such as iron powder into an insulating resin such as epoxy resin.

In the reactor, energizing the coil causes the coil and core to produce heat. Therefore, for improving heat dissipation ability, some reactors have inner cores each of which is metallic, columnar and disposed at the inner periphery side of the coil. At least a part of the inner core is formed as a projection projecting from the bottom of the case to inside of the case. The case and the projection are formed in one piece through a die casting process.

There is the following problem in the reactor having the above described structure.

The projection composing at least a part of the inner core is formed to project from the bottom of the case. When the case and the projection are formed integrally by using die casting, flowability of molten metal in a cavity of a die is not good. Specifically, as shown in FIG. 1, in the cavity 972 formed by the die 971, it is not easy for the molten metal M to flow from a first portion 951c forming the bottom of the case to a second portion 953c forming the projection due to the structure. The arrow in FIG. 1 shows a flow direction of the molten metal M.

This causes blow holes to be formed readily at the projection composing at least a part of the inner core, which might prohibit enough strength of the inner core including the projection from being secured. The lack of strength causes breakage of the inner core, when the inner core is fastened. The breakage might decrease the heat dissipation ability or increase noise and vibration of the core. Furthermore, the blow holes at the inner core also cause decrease in heat dissipation ability of the inner core.

### SUMMARY

The present disclosure provides a reactor and an electric power converter having the reactor for having less or no blow hole at the inner core and securing strength and heat dissipation ability of the inner core enough.

An exemplary embodiment provides a reactor having a coil and a case in which the coil is disposed. The case has a projection which projects from an inner surface of the case and extends along the axial direction of the coil. The outer surface of the case is concave at the position of the projection.

### BRIEF DESCRIPTION OF THE DRAWINGS

In the accompanying drawings:

FIG. 1 is a cross-sectional view showing a manufacturing process of a reactor of the related art using die casting;

FIG. 2 Is a cross-sectional view of a reactor of a first embodiment;

FIG. 3 is a cross-sectional view of a case and a projection of the first embodiment;

FIG. 4 is a bottom view of the case of the first embodiment;

FIG. 5 is a cross-sectional view showing a manufacturing process of the reactor of the first embodiment by using die casting;

FIG. 6 is a cross-sectional view showing a process of combining the case, the projection and a lid in the first embodiment;

FIG. 7 is a cross-sectional view showing a process of bolting the case and the projection in the first embodiment;

FIG. 8 is a cross-sectional view showing a modification of a concave structure at the case;

FIG. 9 is a cross-sectional view showing a modification of a concave structure at the case;

FIG. 10 is a plan view showing a structure of an electric power converter having a reactor in a second embodiment;

FIG. 11 is a perspective view of a frame in the second embodiment;

FIG. 12 is a plan view of the frame in the second embodiment;

FIG. 13 is a bottom view of the frame in the second embodiment.

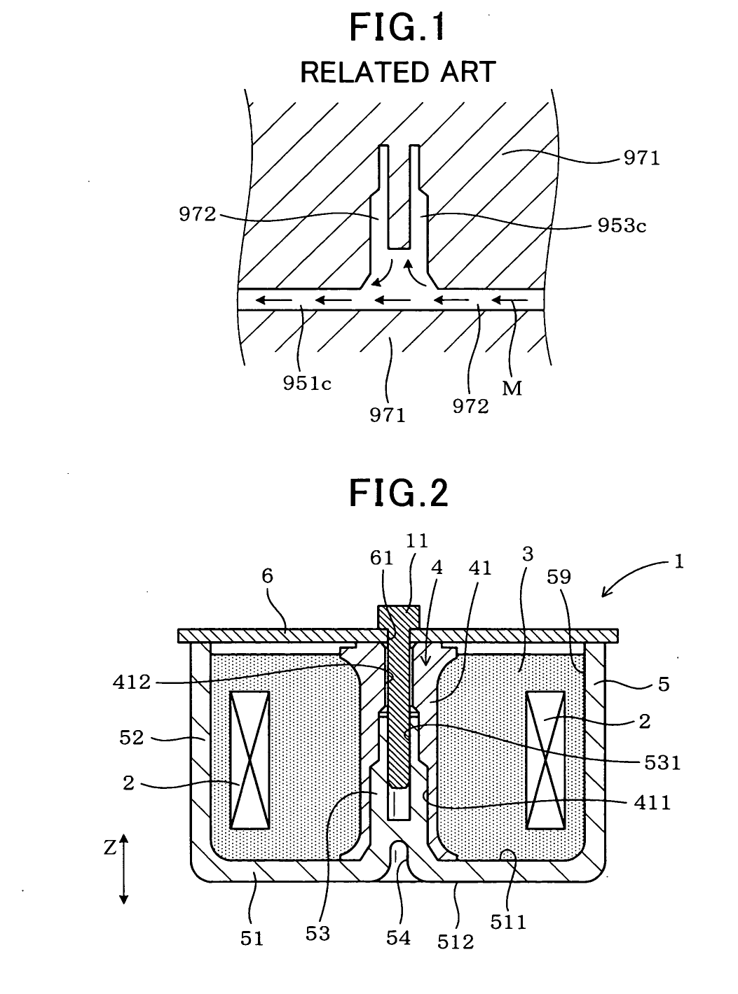

### DETAILED DESCRIPTION OF PREFERRED EMBODIMENTS

### First Embodiment

A first embodiment, an example of electric reactor, will be described with reference to FIG. 2 to FIG. 9.

The reactor 1 of this embodiment, as shown in FIG. 2 to FIG. 4, has a cylindrical coil 2, a core 3, an inner core 4 and a case 5. The coil 2 is energized to create a magnetic flux. The core 3 Is composed of materials including magnetic powder mixed resin which is made by mixing magnetic powder into resin. The coil 2 is buried in the core 3. The columnar inner core 4 extending along the axial direction z of the coil 2 is disposed inside of the coil 2. The case 5 is formed in a box shape which has a bottom 51 at an end in the axial direction z, and the other end of the case 5 is opened. The coil 2, the core 3 and the inner core 4 are disposed in the case 5.

The case 5 has a projection 53 which projects from an inner surface 511 of the bottom 51 along the axial direction z. The projection 53 composes a part of the inner core 4. The case 5 and the projection 53 are formed in one piece by using die casting. The bottom 51 of the case 5 has a concave portion 54 at a position where the projection 53 is formed, the concave portion 54 being concave from an outer surface 512 toward the projecting direction of the projection 53.

The reactor 1 is described in detail below.

The reactor 1 in FIG. 2 is used, for example, for a vehicle-mounted electric power converter such as an inverter or a DC-DC converter.

The reactor 1 has the coil 2 which is energized to create a magnetic flux, the core 3 which forms a magnetic path of the magnetic flux created by energizing the coil 2, the inner core 4 which transfers heat generated at the coil 2 and the core 3 to dissipate it, and, the case 5 in which the coil 2 and the core 3 are disposed.

The coil 2 has conductor wire (not shown In drawings) which consists of copper wire and is spirally wound to be formed in a cylindrical shape. The coil 2 is buried in the core 3.

The core 3 consists of magnetic powder mixed resin made by mixing iron powder as magnetic powder into epoxy resin as insulating resin. The core 3 is disposed such that the core 3 covers the whole of the coil 2. The core 3 is disposed in the case 5 with the coil 2.

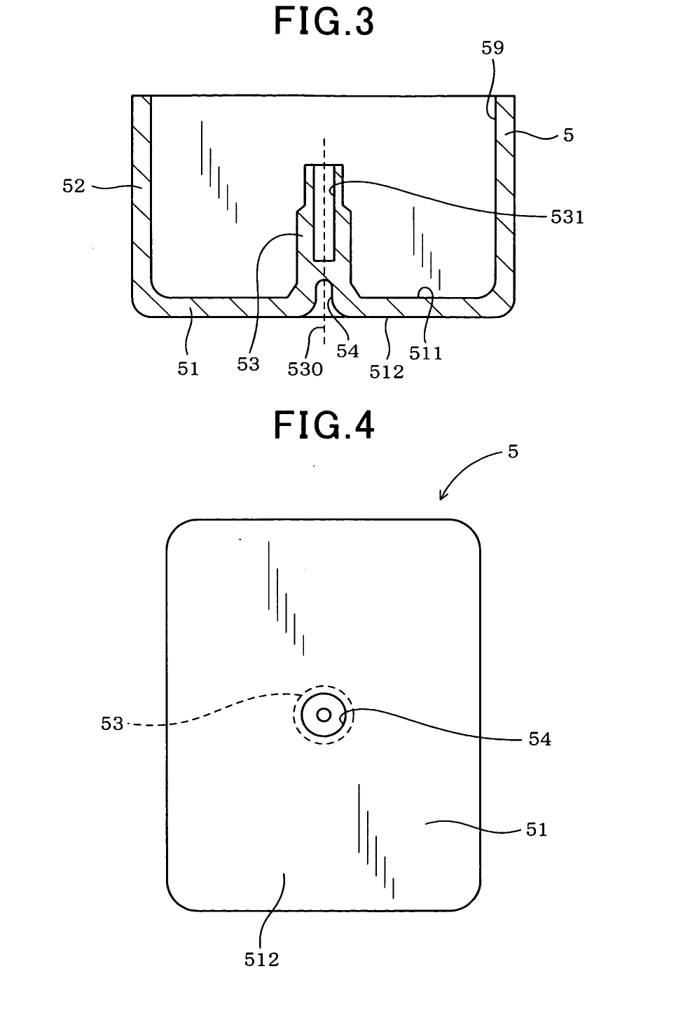

As shown in FIG. 2 and FIG. 3, the case 5 has the bottom 51 shaped like a plate and a side wall 52 extending from the periphery of the bottom 51, and the case S is formed in a box shape having an open end 59 in the axial direction z.

The case 5 has the projection 53 which projects from the inner surface 511 of the bottom 51 along the axial direction z. The projection 53 composes a part of the inner core 4, and is fitted in a fitting portion 411 (described below) of a main body 41. of the inner core 4. The projection 53 has an attachment hole 531 having an internal screw to which a bolt 11 is attached.

As shown in FIG. 2 to FIG. 4; the bottom 54 of the case 5 has the concave portion 54 at the position where the projection 53 is formed. The concave portion 54 is concave from the outer surface 512 of the bottom 51 toward the projecting direction of the projection 53.

As shown in FIG. 3, the concave portion 54 is formed like a cylindrical column on a central axis 530 of the projection 53. The concave portion 54 is more deeply concave than the position of the inner surface 511 toward the projecting direction of the projection 53. The bottom of the concave portion 54 is a curved surface, and the diameter of the concave portion 54 near the open end is larger as the position approaches to the outer surface 512.

As shown in FIG. 2 and FIG. 3, the case 5 and the projection 53 are composed of aluminum alloy, and formed integrally by using die casting. Materials of the case 5 and the projection 53 are not limited to aluminum alloy, but using aluminum alloy can secure strength, heat dissipation ability, resistance to water, anticorrosion and so on.

As shown in FIG. 2, the open end 59 of the case 5 is closed with a plate-like lid 6. The lid 6 has a insertion hole 61 in which the bolt 11 is inserted.

As shown in FIG. 2, the columnar inner core 4 is disposed along the axial direction z to penetrate inside of the coil 2. The inner core 4 has the projection 53 formed at the case 5 and the main body 41 fitted on the projection 53.

The main body 41 has the fitting portion 411 in which the projection 53 is fitted. The main body 41 has a through-hole 412 in which the bolt 11 is inserted. The through-hole 412 penetrates from an end of axial direction z of the main body 41 to the fitting portion 411. The through-hole 412 is connected to the attachment hole 531 of the projection 53 and the insertion hole 61 of the lid 6.

The main body 41 is fastened to the case 5, using the bolt 11. Specifically, in a state where the projection 53 is fitted in the fitting portion 411 of the main body 41, the bolt 11 is inserted through the insertion hole 61 of the lid 6 and the through-hole 412 of the main body 41, and is fitted to the attachment hole 531 of the projection 53 with mating of screw threads. The main body 41 is composed of aluminum alloy and formed by using die casting.

A manufacturing method of the reactor 1 in this embodiment is described below.

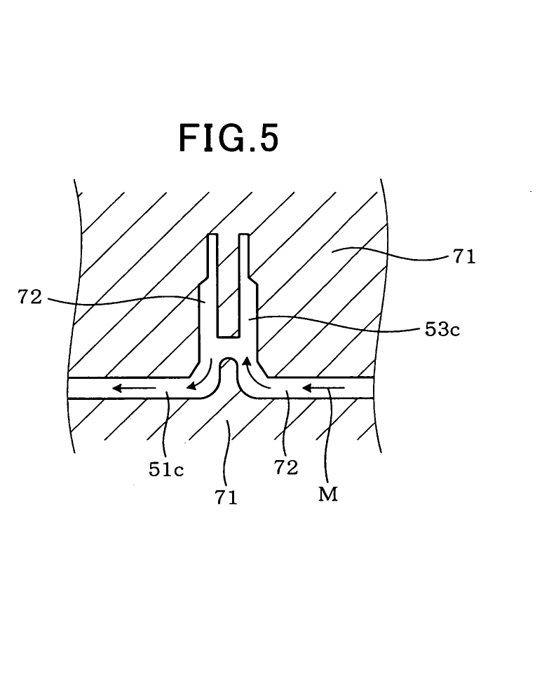

At first, the case 5 and the projection 53 are formed in one piece by using die casting. Specifically, as shown in FIG. 5, a plurality of dies 71 are used, and molten metal M (molten aluminum alloy) is forced into a cavity 72 created by the dies 71 and solidified. Then, the dies 71 are released, and the molded piece is removed.

FIG. 5 shows a plurality of dies 71 and the cavity 72 in the dies 71. The cavity 72 has a first portion 51c forming the bottom 51 of the case 5 and a second portion 53c forming the projection 53. The arrow in FIG. 5 shows the flow direction of the molten metal M.

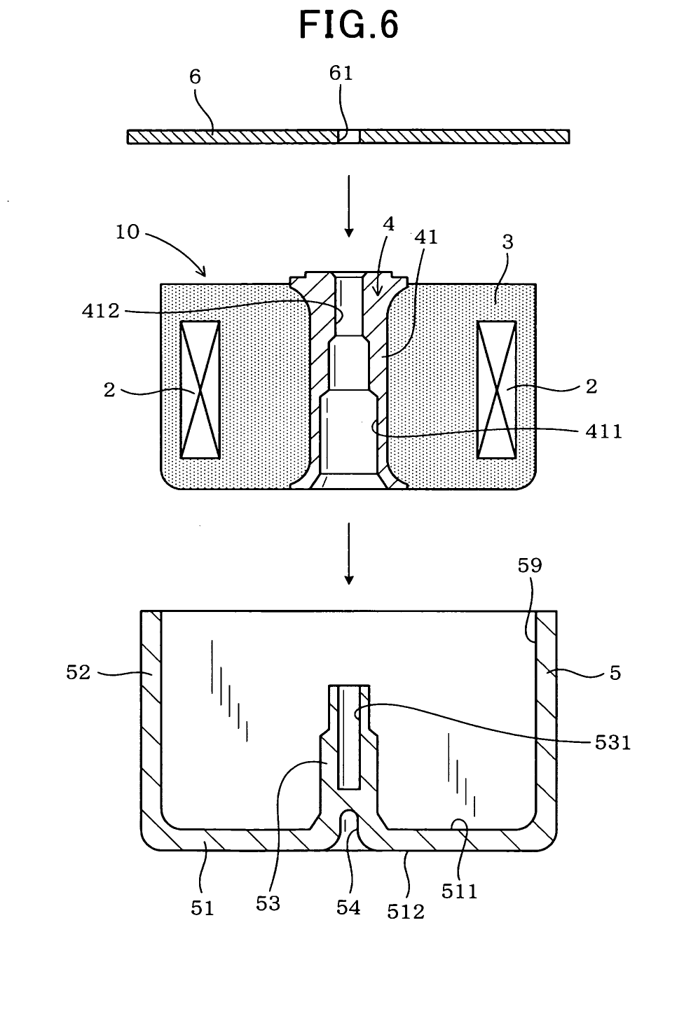

Next, an intermediate 10 made in advance, a combination of the coil 2, the core 3 and the main body 41, is combined with the molded case 5′and projection 53, as shown In FIG. 6. At this time, the projection 53 is fitted to the fitting portion 411 of the main body 41. Then, the open end 59 of the case 5 is closed by the lid 6.

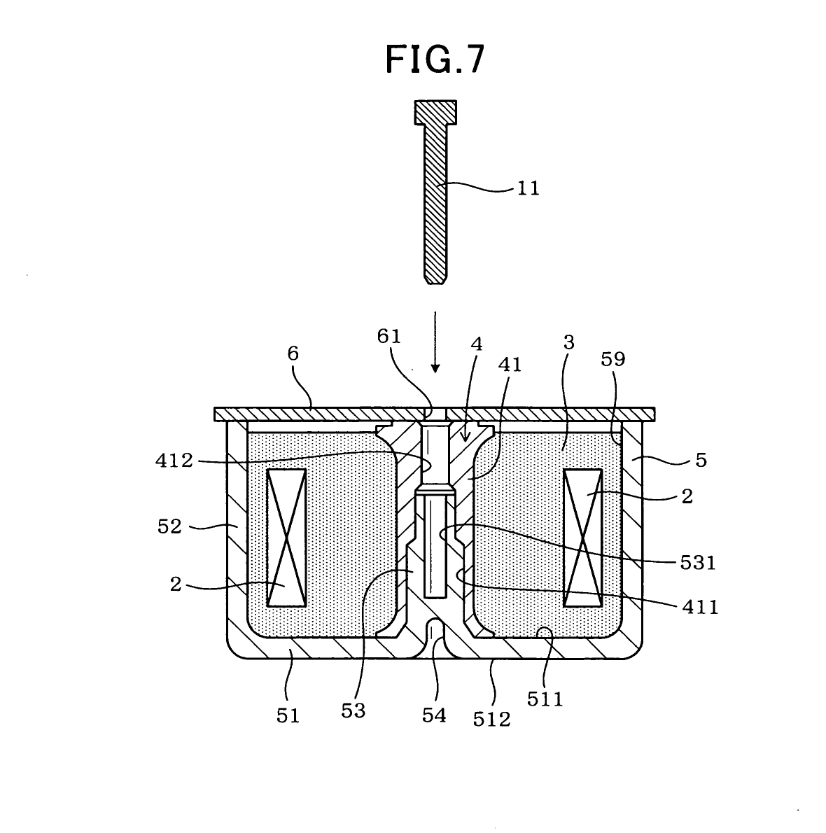

After that, as shown in FIG. 7, the bolt 11 is inserted in the insertion hole 61 of the lid 6 and the through-hole 412 of the main body 41, and is fitted to the attachment hole 531 of the projection 53 with mating of screw threads.

Thus, the reactor 1 shown in FIG. 2 is manufactured.

Effects of the first embodiment are described below.

In this embodiment, the case 5 in which the coil 2, the core 3 and the inner core 4 are disposed has the projection 53 which projects from the inner-surface 511 of the bottom 51 along the axial direction z of the coil 2. The case 5 and the projection 53 are formed in one piece by die casting. The bottom 51 of the case 5 has the concave portion 54 at the position coaxial with the projection 53 is formed, the concave portion 54 is concave from the outer surface 512 of the bottom 51 toward the projecting direction of the projection 53.

Therefore, as shown in FIG. 5, when the case 5 and the projection 53 are formed in one piece by die casting, in the cavity 72 of the dies 71, the molten metal M can flow from the first portion 51c (described as “the bottom 51 of the case 5” below) into the second portion 53c (described as “the projection 53” below) easily. Specifically, the molten metal M in the bottom 51 of the case 5 tends to flow in the projecting direction of the projection 53 such as to go around the concave portion 54. In other words, the concave portion 54 can direct the molten metal M in the bottom 51 of the case 5 to the projection 53 (refer to FIG. 5).

As described above, in this embodiment, the molten metal M can flow from the bottom 51 of the case 5 into the projection easily, that is to say, flowability of the molten metal is improved. Therefore, a good-quality projection 53 can be formed. Specifically, this embodiment can prevent blow holes from occurring at the inner core 4 including the projection 53, which can prevent strength and heat dissipation ability of the inner core 4 from decreasing due to the blow holes.

Therefore, the inner core 4 can have enough strength to prevent breakage of the inner core 4 and negative effect due to the breakage such as decrease in heat dissipation ability and increase in noise and vibration. Furthermore, heat dissipation ability of the inner core 4 is secured sufficiently and the reactor 1 having the inner core 4 can have enough heat dissipation.

In this embodiment, the concave portion 54 of the case 5 is formed on the central axis 530 of the projection 53. This can make the flow of the molten metal M from the bottom 51 to the projection 53 uniform, when forming the case 5 and the projection 53. Therefore, flowability of the molten metal M in the projection 53 is further Improved.

The bottom of the concave portion 54 of the case 5 is concave inside the case 5 more deeply than the plane in which the inner surface 511 is disposed. This allows the molten metal M to flow from the bottom 51 to the projection 53 certainly, when forming the case 5 and the projection 53 by using die casting. Therefore, flowability of the molten metal M in the projection 53 is further improved.

As above described, this embodiment can provides the reactor 1 which can prevent blow holes from occurring at the inner core 4 and secure enough strength and heat dissipation of the inner core 4.

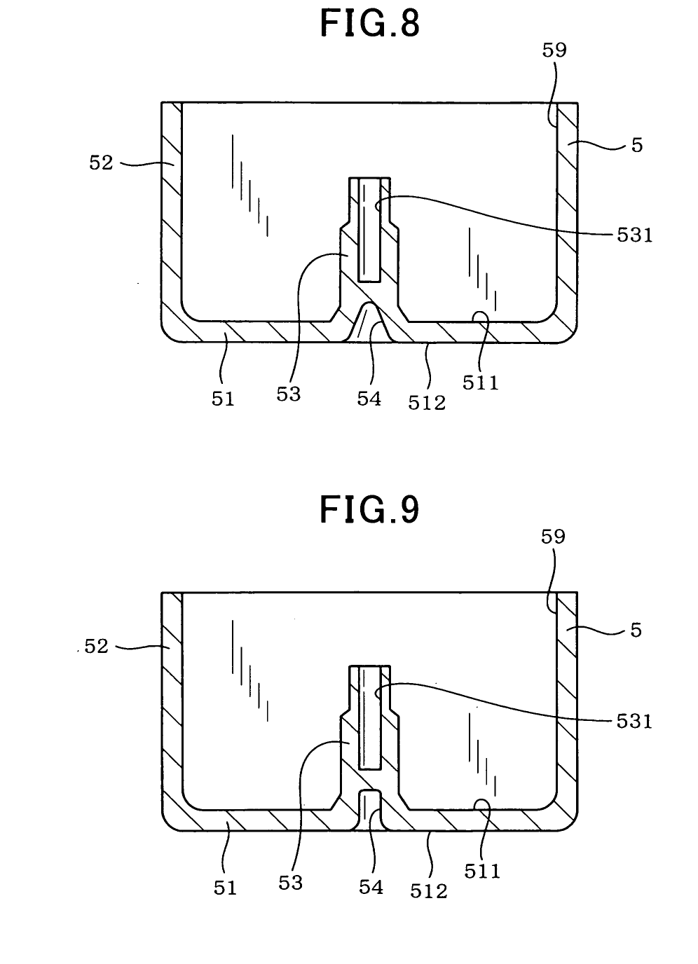

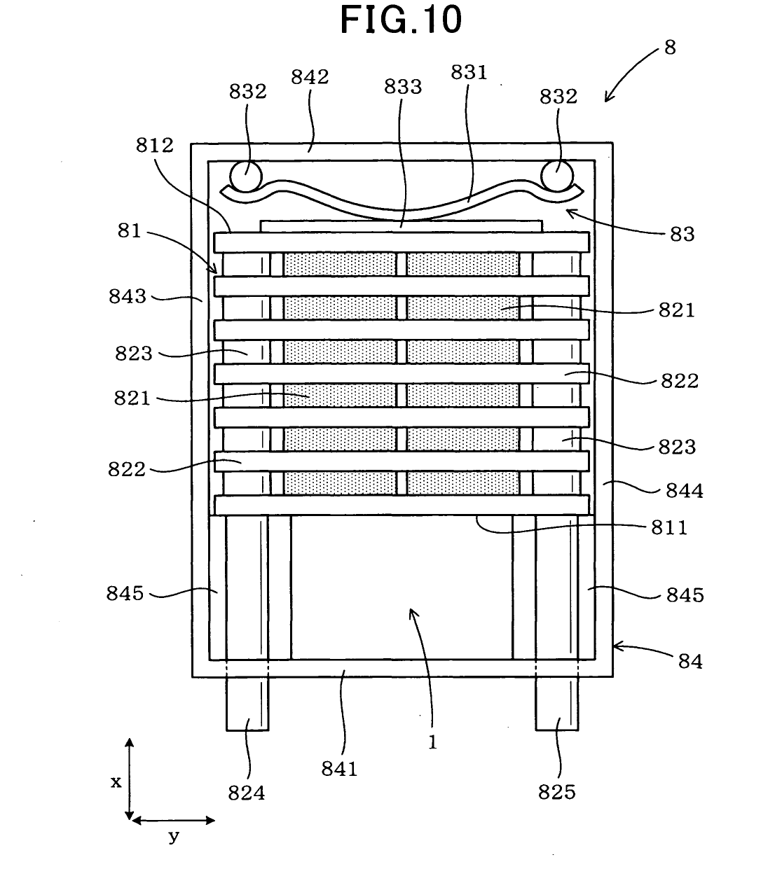

In place of the concave portion 54 having the shape shown in FIG. 2 and FIG. 3, for example, a concave portion 54 which is substantially triangular In cross-section as shown in FIG. 8, or a concave portion 54 which is substantially quadrangular in cross-section as shown in FIG. 9 may be used.

That is to say, those skilled in the art can set a shape or size of the concave portion 54 and so on freely without departing from the effect of this disclosure, the effect being that the molten metal M can flow from the bottom 51 to the projection 53 easily when forming the case 5 and the projection 53.

The structure of the projection Is not limited to the first embodiment in the present invention. Instead of the projection 53 composing a part of the inner core 4, a projection composing the entire inner core may be applied.

### Second Embodiment

A second embodiment, an example of electric power converter 8 using the reactor 1 of the first embodiment, will be described with reference to FIG. 10 to FIG. 13.

The power converter 8 has, as shown in the drawings, a plurality of electric parts composing a power converter circuit and including the reactor 1 of the first embodiment, and, a frame 84 in which the electric parts are disposed. The frame 84 is formed with the case 5 of the reactor 1 and the projection 53 in one piece by using die casting.

This is described in detail below.

In this embodiment, as shown in FIG. 10, a direction along which semiconductor modules 821 and cooling pipes 822 (both described below) are stacked is described as a stack direction x, and, the longitudinal direction of the cooling pipes 822 is described as a lateral direction y.

In the stack direction x, the direction to which a refrigerant inlet pipe 824 and a refrigerant outlet pipe 825 (both described below) project from the frame 84 is described as a front direction, the opposite direction is described as a rear (back) direction.

As shown in the drawings, the power converter 8, the electric parts composing a power converter circuit, has a stack 81 including the semiconductor modules 821 and the cooling pipes 822 with the semiconductor modules 821 and the cooling pipes 822 are stacked alternatively. The semiconductor modules 821 have semiconductor elements provided therein. Refrigerant flows through the cooling pipes (refrigerant path) 822.

Each semiconductor module 821, each side of the stack direction x, is sandwiched between the cooling pipes 822, and each pair of semiconductor modules 821 are disposed between the adjacent cooling pipes 822. Each semiconductor module 821 has a switching element such as IGBT (Insulated Gate Bipolar Transistor) and a diode such as FWD (Free Wheeling Diode) provided therein (not shown).

Each cooling pipe 822 is connected to the adjacent cooling pipe 822 through a pair of deformable joint pipes 823 at both ends of the longitudinal direction (the lateral direction y) of the cooling pipe 822. Both ends of the cooling pipe 822 disposed at the front end of the stack direction x of the stack 81 are connected to the refrigerant inlet pipe 824 and the refrigerant outlet pipe 825. The refrigerant inlet pipe 824 introduces refrigerant from the outside, the refrigerant outlet pipe 825 emits refrigerant to the outside, and they are partially projected out of the frame 84.

The refrigerant introduced through the refrigerant inlet pipe 824 flows through the joint pipe 823 of the refrigerant inlet pipe 824 side to be distributed to each cooling pipe 822, and flows along the longitudinal direction (lateral direction y) of each cooling pipe 822. The refrigerant exchanges heat with the semiconductor modules 821, while flowing. The refrigerant the temperature of which has increased due to the heat exchange flows through the joint pipe 823 of the refrigerant outlet pipe 825 to be emitted from the refrigerant outlet pipe 825.

For example, natural refrigerant such as water and ammonia; water including ethylene glycol antifreeze; fluorocarbon refrigerant including fluorocarbons such as Fluorinert (Trade Mark); chlorofluorocarbon refrigerant such as HCFC123 and HFC 134a; alcoholic refrigerant such as methanol and alcohol; ketone refrigerant including ketones such as acetone may be used as the refrigerant circulating through the cooling pipes 822 and others.

The reactor 1 is disposed forward of the stack 81. The reactor 1 contacts with a front surface 811 of the stack 81.

A pressing member 83 is disposed backward of the stack 81. The pressing member 83 has an elastic member 831, a pair of support pins 832 and a plate 833. The elastic member 831 generates an elastic force toward the stack 81, for example, is composed of a flat-shaped plate spring, and supported by the support pins 832. The plate 833 is disposed between the elastic member 831 and a rear surface 812 of the stack 81.

The frame 84 is formed such as to surround the stack 81 from all directions (fourth directions in this example), and the reactor 1 and the pressing member 83 are disposed inside of the frame 84. The frame 84 has a front wall portion 841, a rear wall portion 842 and a pair of side wall portions 843, 844. The front wall portion 841 and the rear wall portion 842 are disposed at both sides of the stack direction x of the stack 81. The side wall portions 843, 844 connect between the ends of the front wall portion 841 and the rear wall portion 842. The support pins 832 of the pressing member 83 are disposed between both ends of the elastic member 831 and the rear wall portion 842 of the frame 84.

The elastic member 831 of the pressing member 83 is sandwiched between the support pins 832 and the plate 833 contacting with the rear surface 812 of the stack 81, with the elastic member 831 elastically deformed to the stack direction x. The elastic member 831 presses the rear surface 812 of the stack 81 through the plate 833. Thus, the stack 81 is retained inside of the frame 84 with the stack 81 pressed to the stack direction x by a pressing force of the elastic member 831.

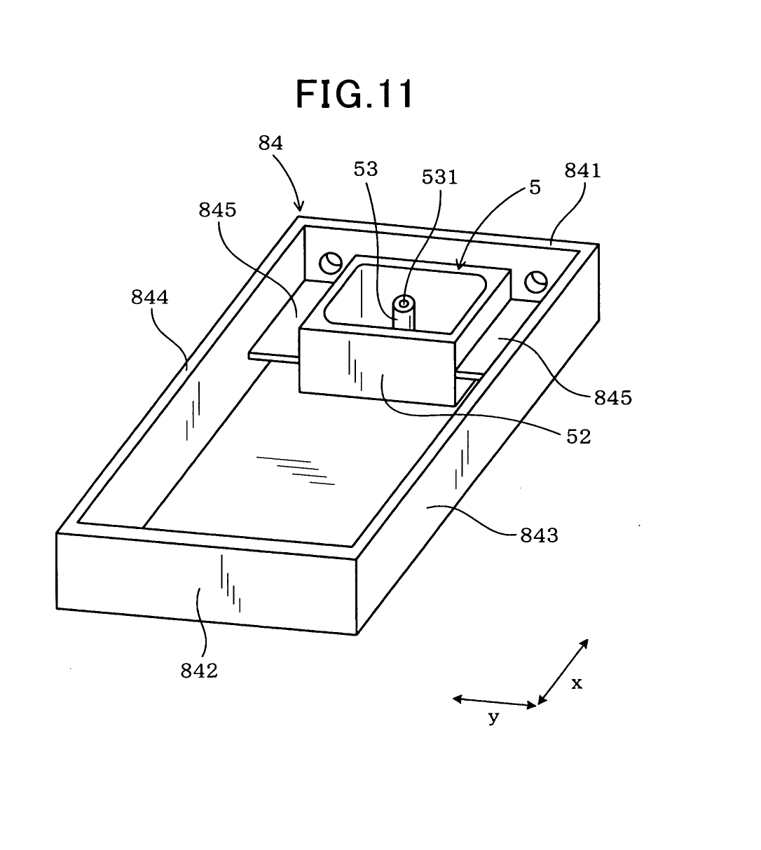

As shown in FIG. 11, the front wall 841 of the frame 84 and the case 5 of the reactor 1 are formed in one piece. A joint portions 845 are formed between the side wall portions 843, 844 of the frame 84 and the side wall 52 of the case 5 of the reactor 1, the joint portions 845 connecting the side wall portions 843, 844 and the side wall 52.

The frame 84 is composed of aluminum alloy and formed with the case 5 of the reactor 1 and the projection 53 in one piece through die casting process.

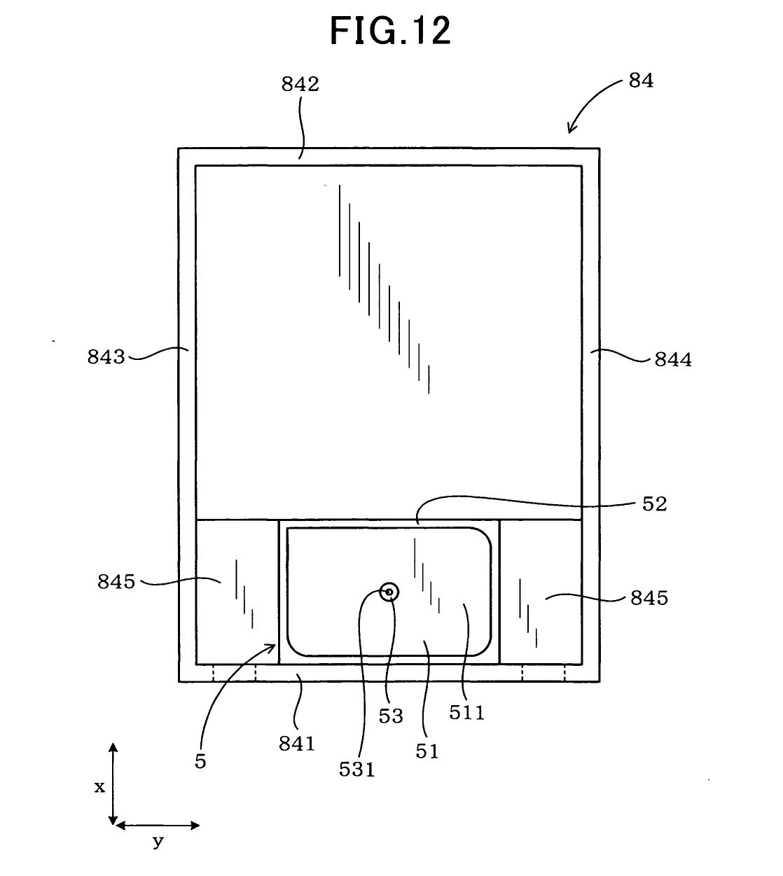

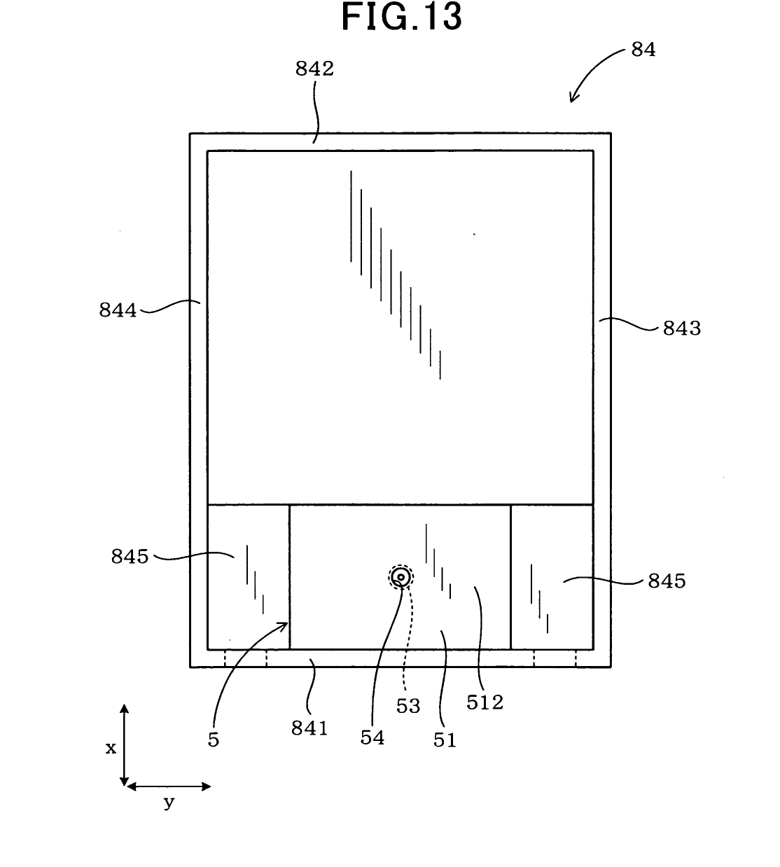

As shown in FIG. 11 and FIG. 12, the projection 53 projecting from the inner surface 511 of the bottom 51 is formed at the case 5.

Furthermore, as shown in FIG. 13, the bottom 51 of the case 5 has the concave portion 54 at the position where the projection 53 is formed, the concave portion 54 being concave from the outer surface 512 of the bottom 51 toward the projection 53.

Effects of the power converter 8 in this embodiment are described below.

In the power converter 8 of this embodiment, the frame 84 in which a plurality of electric parts including the reactor 1 are disposed is formed with the case 5 of the reactor 1 and the projection 53 in one piece by using die casting. Therefore, the case 5 of the reactor 1 and the projection 53 can be formed at the same time as forming the frame 84 by using die casting, and high-quality projections 53 can be formed. This enables projection efficiency to increase, and prevents blow holes from occurring in the inner core 4 including the projection 53. Thus, the power converters 8 which have high-quality and high-performance reactors 1 securing enough strength and heat dissipation ability can be provided.

What is claimed is:

1. A reactor comprising:
a cylindrical coil which is energized to create a magnetic flux;
a core composed of materials including a mixture of resin and magnetic powder, the coil being buried in the core;
an inner core which is provided inside of the coil and extends along an axial direction of the coil; and
a case in which the coil, the core and the inner core are disposed, the case having a bottom which faces an axial end of the coil, wherein:
the case has a projection which projects from an inner surface of the bottom along the axial direction inside of the case, and composes at least a part of the inner core, the projection and the case being formed integrally; and
the inner surface of the bottom of the case is concave at a position where the projection is formed toward a projecting direction of the projection.

2. The reactor according to claim 1, wherein the case having the projection and the concave portion is formed in one piece by using die casting.

3. The reactor according to claim 1, wherein the concave portion of the case is formed on a central axis of the projection.

4. The reactor according to claim 1, wherein the concave portion of the case is formed to be more deeply concave than a position of the inner surface of the bottom.

5. An electric power converter comprising:
an electric power converter circuit including a cylindrical coil which is energized to create a magnetic flux;
a core composed of materials including a mixture of magnetic powder and resin, the coil being buried in the core;
an inner core which is provided inside of the coil and extends along an axial direction of the coil;
a case in which the coil, the core and the inner core are disposed, the case having a bottom which faces an axial end of the coil; and
a frame in which the case and the power converter circuit except the coil are disposed, the frame and the case being formed integrally,
wherein:
the case has a projection which projects from an inner surface of the bottom along the axial direction inside of the case, and composes at least a part of the inner core, the projection and the case being formed integrally; and
the inner surface of the bottom of the case is concave at a position where the projection is formed toward a projecting direction of the projection.
